(19) United States
(12) Patent Application Publication
(10) Pub. No.: US 2024/0202807 A1
(43) Pub. Date: Jun. 20, 2024

(54) METHOD OF BUILIDNG OR CUSTOMIZING A VIRTUAL PROJECT

(71) Applicant: Safa Ventures LLC, Beaverton, OR (US)

(72) Inventor: Navid Safabakhsh, Laguna Beach, CA (US)

(21) Appl. No.: 18/066,171

(22) Filed: Dec. 14, 2022

(51) Int. Cl. G06Q 30/0601; G06F 30/12

(52) U.S. Cl. CPC G06Q 30/0643; G06F 30/12; G06Q 30/0621; G06Q 30/0633; G06F 2111/16

(57) ABSTRACT

A software application is accessible through a web browser and provides a user-friendly interface to build a virtual project in a step-by-step manner. The software application walks the user through a guided virtual build process by starting with a single part. The application iteratively provides lists of compatible parts with the previously assembled parts, and where desired parts cannot be directly connected with a preceding part, an explanation is provided for how the desired parts can be made compatible. When the user has completed the customized virtual project, a parts list for building the project is generated automatically by the application. Additionally, each of the parts included in the parts list can be purchased from a retailer or a number of retailers that carry the parts by utilizing a customized purchase link within the application.

### CROSS-REFERENCE TO RELATED APPLICATIONS

Not Applicable.

### FIELD

The present disclosure relates to a virtual project and, more particularly, to a method of building or customizing the virtual project.

### BACKGROUND

Design tools include objects, media, or computer programs, which can be employed to design a project, such as a frame for a building or other structure. However, conventional design tools often require years of education and training to learn how to use such tools, and thus such tools are often only practically accessible to engineers with formal training. There exists an unmet need for project building software that is user friendly and more accessible to people with little or no engineering experience.

### SUMMARY

The computer-implemented method described herein can be executed as a software application accessible through a web browser or incorporated as a project building link on a website, such as a website for a retailer. The project design or customization software provides a user-friendly interface for building a project virtually in a step-by-step manner. The user is presented with a list of initial parts to get a project started. The user interface then provides a series of parts which can be iteratively added to the initial part to build a virtual project or design. This step-by-step assembly process starting from a single part allows individuals without an engineering background to complete or customize project designs in a virtual space and ultimately generate a list of parts needed to build the virtual project in the real world. That is, projects are built visually and intuitively from the ground up in a build as you go manner, with next steps in the building process intuitively suggested within the user interface. Further, the project design or customization software allows the user to order all parts from the list from either a single or multiple retailers. This allows the parts included in the final design to be easily “snapped together” following delivery.

Provided in accordance with aspects of the present disclosure is a computer-implemented method of building a virtual project includes providing a user interface to a user. The user interface includes a new project initiation button configured to be executed by the user to start building a virtual project. A list of initial components is displayed to the user. Each component included in the list of initial components can be connected with other components to start building the virtual project. A selection of a starting component from the list of initial components is received from the user. The starting component is displayed in the user interface. The starting component displayed in the user interface includes at least one portion configured to connect with another component. An expansion tab is displayed in the user interface adjacent the portion of the starting component configured to connect with another component. Executing the expansion tab is configured to generate a list of compatible parts for the portion of the starting component. The list of compatible parts is displayed to the user. Each compatible part included in the list of compatible parts is configured to connect with the portion of the starting component. A signal is received from the user indicating a selected compatible part from the list of compatible parts. The selected compatible part is displayed connected with the portion of the starting component in the user interface. The displayed selected compatible part connected with the portion of the starting component represents a partially built virtual project. Additional expansion tabs are iteratively displayed about the partially built virtual project and corresponding additional lists of compatible parts are displayed for each of the additional expansion tabs. A signal is received from the user that the virtual project is complete. A digital parts list for building the completed virtual project is generated. The digital parts list is executable to purchase each part included in the digital parts list.

In an aspect of the present disclosure, a signal to purchase at least some of the parts included in the digital parts list is received.

In an aspect of the present disclosure, a list of at least one retailer at which the at least some of the parts included in the digital parts list are available for purchase is displayed.

In an aspect of the present disclosure, a list of incompatible parts for the portion of the starting component is displayed. The incompatible parts could be made to be compatible with the portion of the starting component.

In an aspect of the present disclosure, an explanation for why the incompatible parts are incompatible with the portion of the starting component is displayed.

In an aspect of the present disclosure, a suggestion is displayed for how the make the incompatible parts compatible with the portion of the starting component.

In an aspect of the present disclosure, the list of compatible parts for the portion of the starting component includes a size of the compatible parts, a material included in the compatible parts, or a class of the incompatible parts.

In an aspect of the present disclosure, the user interface is a 3-dimensional (3-D) interface.

In an aspect of the present disclosure, the user interface is configured to rotate the starting component, the selected compatible part, or the partially built virtual project.

In an aspect of the present disclosure, the user interface is configured to modify a size or a length of the starting component, or the selected compatible part.

In an aspect of the present disclosure, a list of pre-built virtual projects is displayed to the user, and the user selects one of the pre-built virtual projects instead of selecting a single starting component. The pre-built virtual project can then be customized by expanding a series of expansion tabs and selecting compatible parts, or incompatible parts that are made to be compatible.

### BRIEF DESCRIPTION OF THE DRAWINGS

Various aspects and features of the present disclosure are described hereinbelow with reference to the drawings wherein:

FIG. 1 is a block diagram of a web browser displaying a user interface of a software application according to aspects of the present disclosure;

FIG. 2 is a flow chart illustrating a method of building a virtual project according to aspects of the present disclosure;

FIG. 3 is an illustration of the user interface of FIG. 1 displaying a new project initiation button;

FIG. 4 is an illustration of the user interface of FIG. 1 displaying a list of initial components;

FIG. 5 is an illustration of the user interface of FIG. 1 displaying a starting component and a number of expansion tabs;

FIG. 6 is an illustration of the user interface of FIG. 1 displaying a list of compatible parts corresponding with one of the expansion tabs of FIG. 5;

FIG. 7 is an illustration of the user interface of FIG. 1 displaying a length editing tab for a component included in a partially built virtual project;

FIG. 8 is an illustration of the user interface of FIG. 1 displaying how a component can connect with another component by a snap-fit connection;

FIG. 9 is an illustration of the user interface of FIG. 1 displaying a list of incompatible parts for an expansion tab;

FIG. 10A is an illustration of the user interface of FIG. 1 displaying a first intervening part configured to make an incompatible part compatible with a component of a partially built virtual project;

FIG. 10B is an illustration of the user interface of FIG. 1 displaying a second intervening part added to the first intervening part of FIG. 10A to make the incompatible part compatible with the component of the partially built virtual project;

FIG. 10C is an illustration of the user interface of FIG. 1 displaying the initially incompatible part that is now compatible with the component of the partially built virtual project;

FIG. 10D is an illustration of the user interface of FIG. 1 displaying a generated digital list of parts needed to build a virtual project and a purchase link to purchase the needed parts;

FIG. 11 is an illustration of the user interface of FIG. 1 displaying a pre-built virtual project that can be customized by a user; and

FIG. 12 is a block diagram of an exemplary computer employable to execute the methods and algorithms described herein according to aspects of the present disclosure.

### DETAILED DESCRIPTION

The software application according to aspects of the present disclosure allows a user to build a virtual project 100 within a highly user-friendly user interface 101 on step-by-step basis. After initiating a new project using a project initiation button 102, the application provides a list of parts 103 that can be employed to get a project started. Beginning with a single starting component 105, a user is prompted to add additional parts at each portion 106 of the starting component 105 that can receive additional components by a series of easily understood expansion tabs 107. After each expansion tab 107 is clicked, a list of compatible parts 108 is displayed. After each new part is added, additional expansion tabs 107 are displayed to guide a user through the build process. The application gradually walks a user through project builds, such as project builds for custom aquaponics projects, chicken coop frames, or green house frames. When the virtual project build is completed, the application can provide a complete digital parts list 111 including all parts 112 needed to build the project. The application also allows a user to purchase each of the products from the digital parts list 111 by simply clicking an order button.

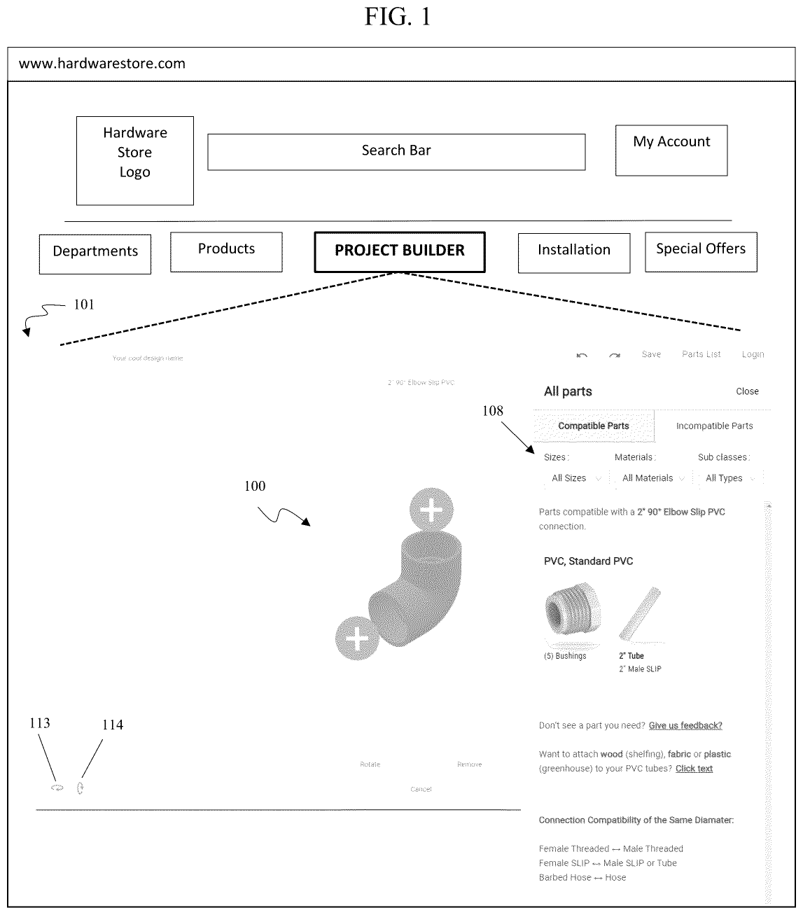

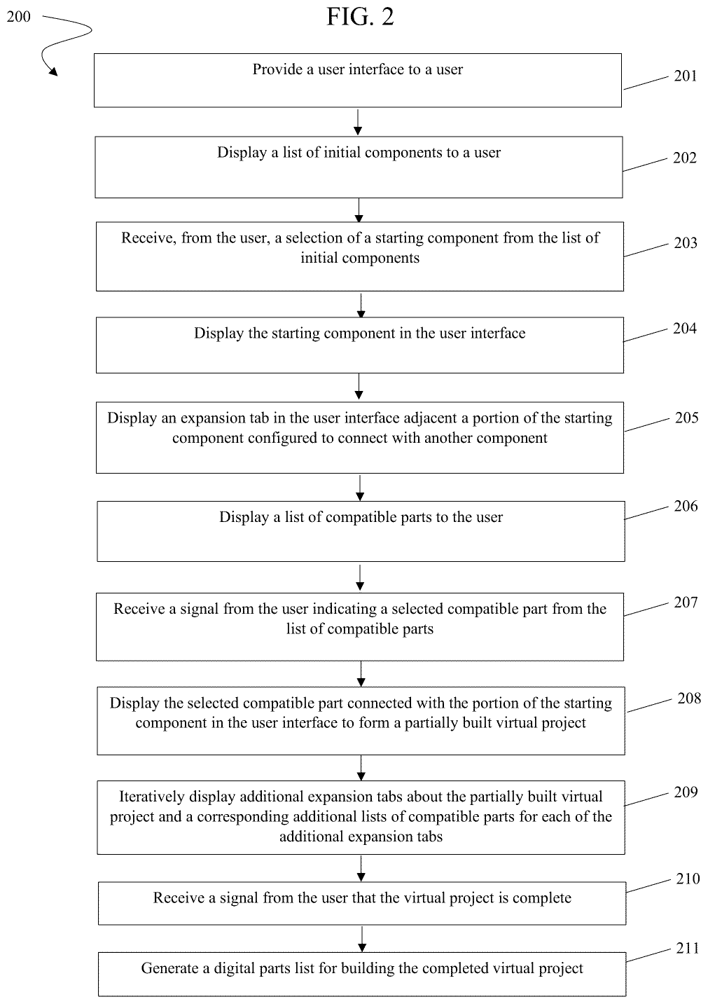

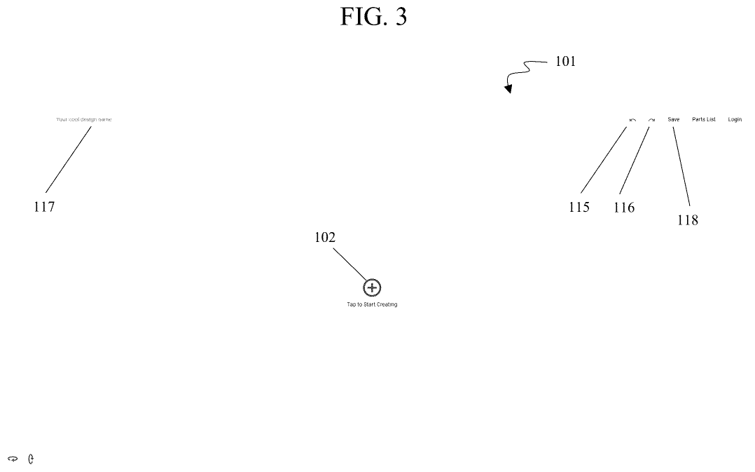

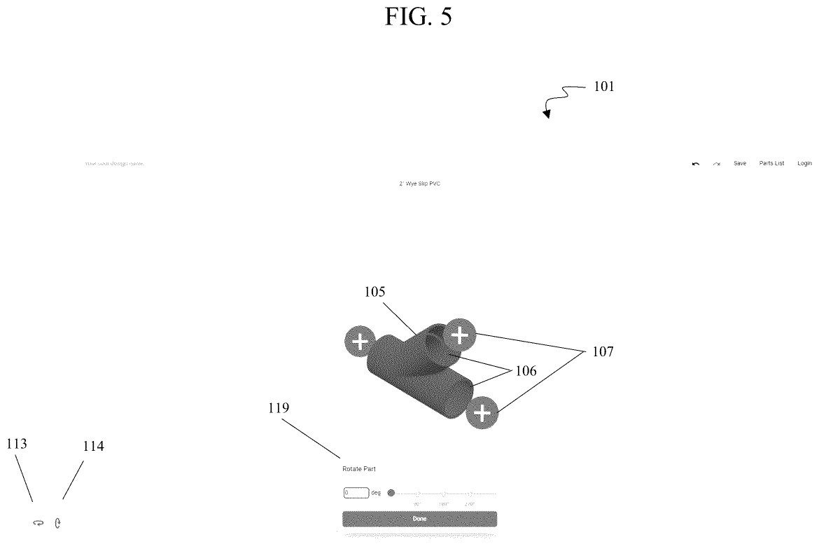

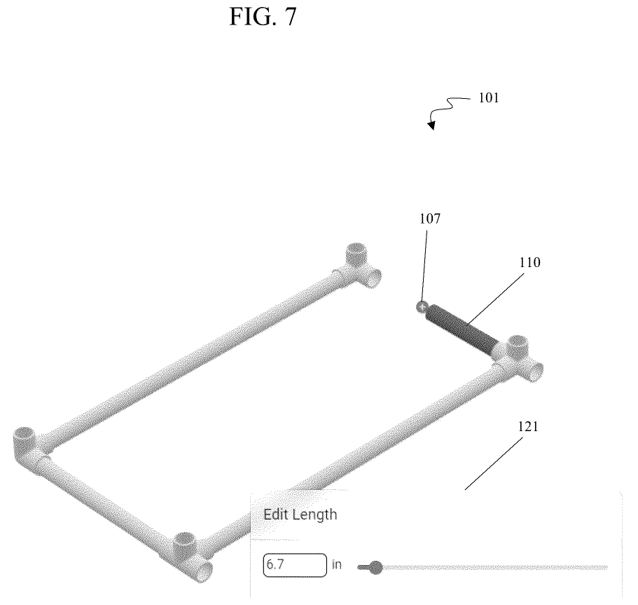

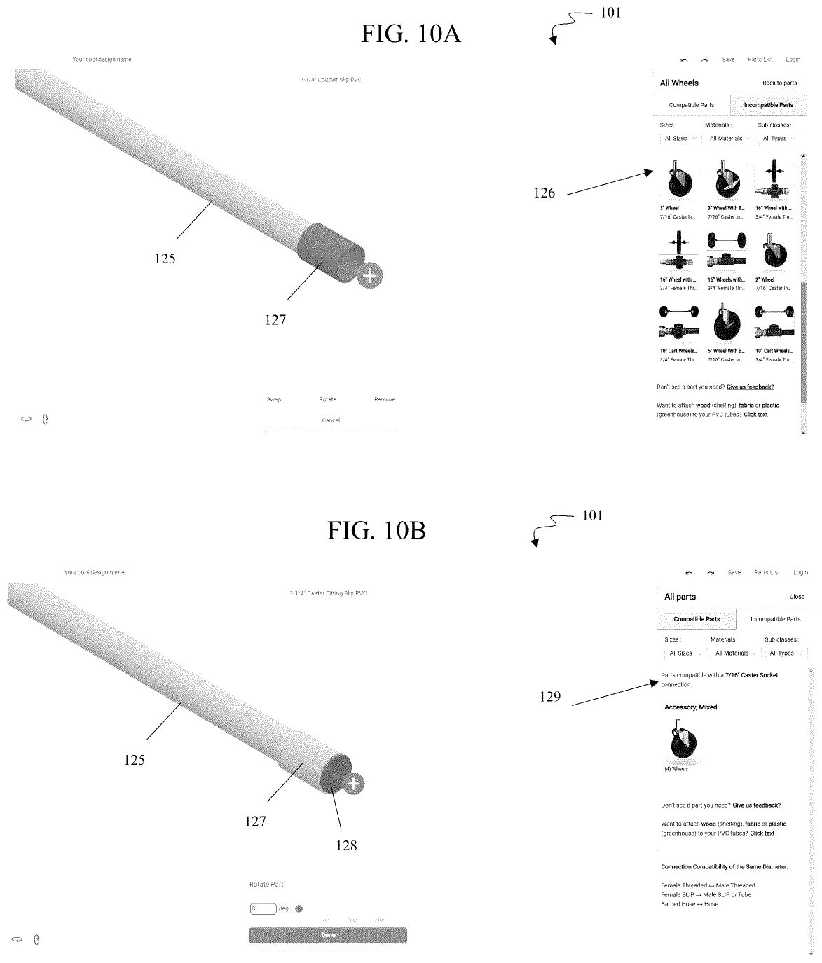

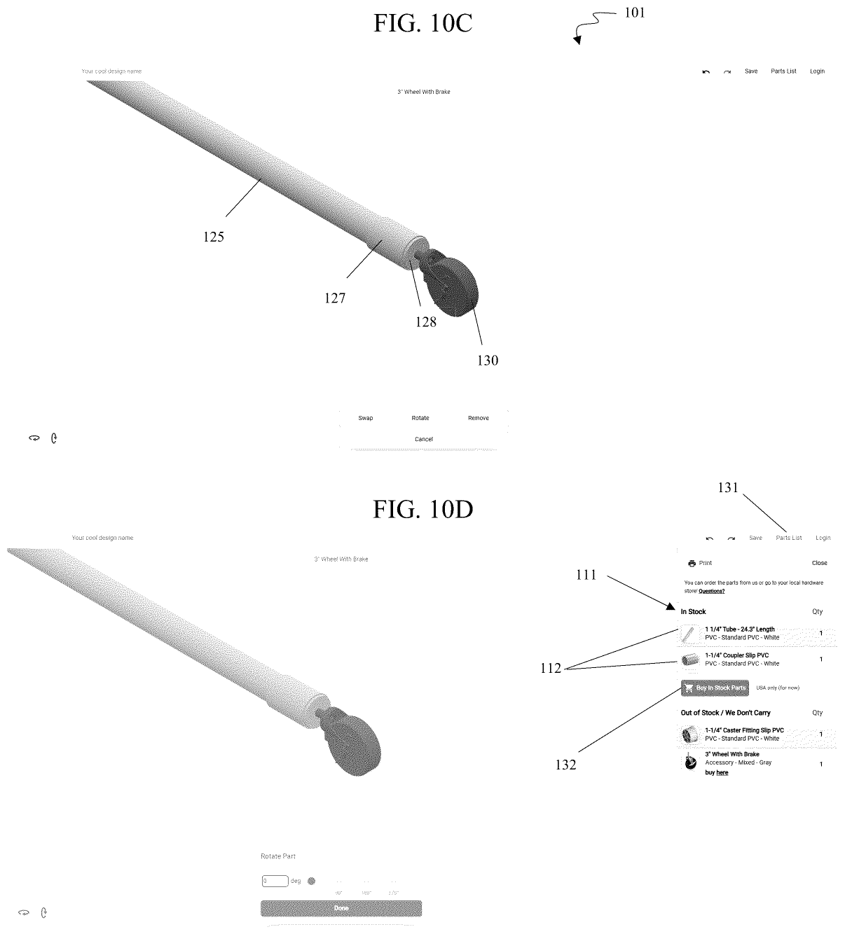

Referring particularly to FIGS. 1 and 2, a computer-implemented method (200) of building a virtual project 100 includes providing a user interface 101 to a user (step 201). The user interface 101 includes a new project initiation button (see, e.g., button 102 in FIG. 3) configured to be executed by the user to start building the virtual project 100. A list of initial components 103 is displayed to the user (step 202). Each component 104 included in the list of initial components 103 can be connected with other components to start building the virtual project 100. A selection of a starting component (see, e.g., component 105 in FIG. 5) from the list of initial components 103 is received from the user (step 203). The starting component 105 is displayed in the user interface 101 (step 204). The starting component 105 displayed in the user interface 101 includes at least one portion 106 configured to connect with another component. An expansion tab 107 (e.g., plus sign as shown in FIG. 5) is displayed in the user interface 101 adjacent the portion(s) 106 of the starting component 105 configured to connect with another component (step 205). Executing the expansion tab(s) 107 is configured to generate a list of compatible parts 108 for the portion(s) 106 of the starting component 105. The list of compatible parts 108 is displayed to the user (step 206). Each compatible part 109 included in the list of compatible parts 108 is configured to connect with the selected portion 106 of the starting component 105. A signal is received from the user indicating a selected compatible part 110 (see, e.g., selected compatible part 110 in FIG. 7) from the list of compatible parts 108 (step 207). The selected compatible part 110 is displayed connected with the portion of the starting component in the user interface (step 208). The displayed selected compatible part 110 connected with the portion 106 of the starting component 105 represents a partially built virtual project. Additional expansion tabs (sec, e.g., expansion tab 107 in FIG. 7) are iteratively displayed about the partially built virtual project and corresponding additional lists of compatible parts are displayed for each of the additional expansion tabs (step 209). A signal is received from the user that the virtual project 100 is complete (step 210). A digital parts list (see, e.g., digital parts list 111 in FIG. 10D) for building the completed virtual project is generated (step 211). The digital parts list 111 is executable to purchase each part 112 included in the digital parts list 111.

In an aspect of the present disclosure, the user interface 101 is a 3-dimensional (3-D) interface. The user interface 101 allows a user to rotate any individual component, a partially built virtual project, or a completed virtual project in 3D space. For example, rotation tabs 113 and 114 may be provided to facilitate intuitive rotation of the individual component, the partially built virtual project, or the completed virtual project in 3D space.

Referring particularly to FIG. 3, a new virtual project can be started by clicking the project initiation button 102. As an example, the project initiation button 102 may display a helpful description, such as “tap to start creating” along with a plus symbol to suggest to the user where the next step in utilizing the application can be executed. The visual symbols displayed, such as the plus symbol, may be used continually by the application to maintain a sense of continuity and to intuitively guide the user through the application. Any step can be undone or repeated by clicking an undo tab 115 or a repeat tab 116.

Each virtual project may be given a custom name, such as by entering a name in a name entry filed 117, and the virtual project can be saved at any time by clicking a “save” button 118 displayed in the user interface 101.

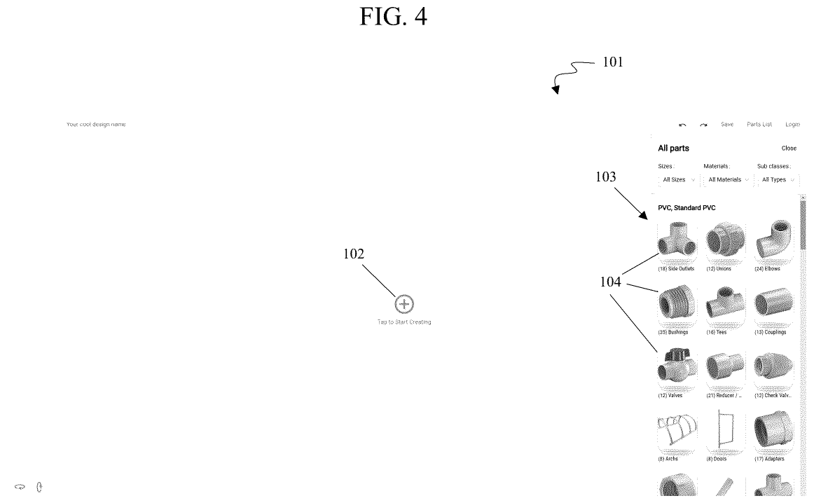

Referring particularly to FIG. 4, after a user clicks on the project initiation tab 102, the user is presented with the list of components 103 that can be used in getting a virtual project build started.

The list of initial components 103 includes a digital image of each component 104 included in the list of initial components 103. The digital image assists the user in visualizing the starting component 105 and how a compatible part 109 will connect with the starting component 105 or any other previously selected component 104.

The list of compatible parts 103 displays a size of the compatible parts 104, a material included in the compatible parts 104, or a class of the compatible parts 104. For example, the material included in the compatible parts 104 may be wood, metal, plastic, a composite material, or a material such as polyvinyl chloride (PVC). The class (or subclass) of the compatible parts 104 may be used to reorganize the list of compatible parts 103 to display more relevant parts to the user. For example, the class (or subclass) options may include thin PVC, standard PVC, brass, steel, black steel, mixed, wood, a particular wood type (e.g., plywood, oak, or pine), or any other desired descriptor that can further be used to organize the list of compatible parts 103 to assist a user in identifying a desired part.

Referring particularly to FIG. 5, after a user selects the starting component 105, the starting component 105 is displayed in the user interface 101. The user interface 101 is configured to rotate the starting component 105, any selected compatible part 109, or the partially built virtual project.

Rotation may be achieved in the user interface by utilizing rotation tabs 113 and 114, or by using a rotation slide window 119. The rotation slide window 119 allows a precise degree of rotation to be entered to rotate the component(s) displayed in the user interface 101 to any desired angle.

A number of expansion tabs 107, each corresponding with a portion 106 of the displayed component 105 which can receive additional components are displayed. Clicking on each expansion tab 107 will trigger a display of a corresponding list of compatible parts 108 for a particular expansion tab 107 corresponding with a particular portion 106 of the displayed component(s).

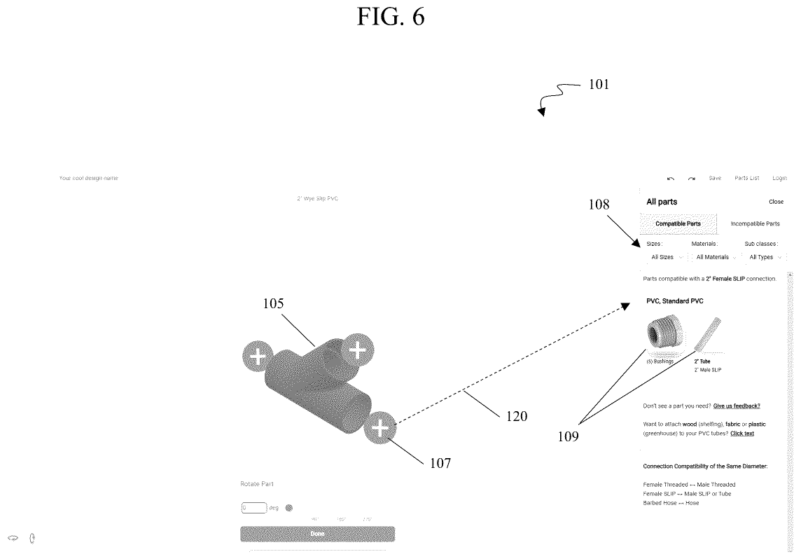

Referring particularly to FIG. 6, when a particular expansion tab 107 is clicked, a corresponding list of compatible parts 108 is displayed showing parts 109 that correspond with the location of the particular expansion tab 107 (see, e.g., dashed line 120 indicating which expansion tab 107 has been clicked). A digital image of each part 109 is displayed, along with suggestions on how to expand the list of compatible parts 108 to include additional parts. As described in more detail below, a list of incompatible parts 122 may also be accessed, along with explanations or suggestions for how the incompatible parts can be made compatible with the component(s) displayed in the user interface 101.

Referring particularly to FIG. 7, the length of the selected compatible part 110 can be modified in the user interface 101. As an example, a length editing tab 121 can be employed to modify the length of the selected compatible part 110.

A maximum length of a selected component (e.g., the tube 110 illustrated in FIG. 7) can be limited by the previously selected components. For example, the tube may be aligned with one opening of a 3-way outlet, and thus the position of the 3-way outlet may limited how much a length of the tube can be expanded.

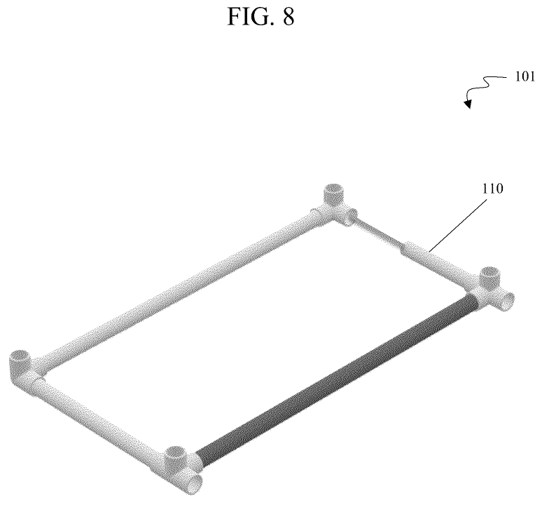

Referring to FIG. 8, the user interface 101 may indicate how one expanded component (e.g., the selected compatible part 110) will “snap into” another component. FIG. 8 illustrates an example in which an expanded tube can “snape into” a 3-way outlet to further assemble a virtual project. This information assists the user in visualizing how parts can be expanded to connect with other parts, and how the selected components will ultimately be assembled into the desired project structure.

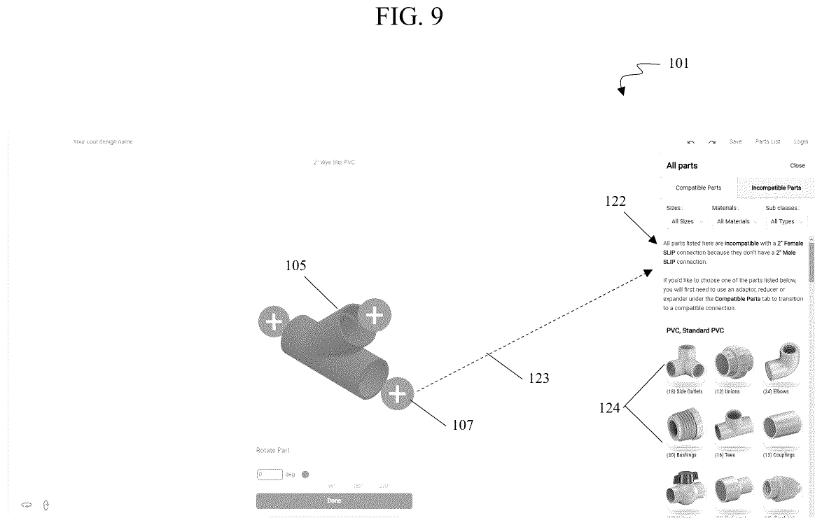

Referring to FIGS. 9 and 10A-10C, a list of incompatible parts 122 for a corresponding expansion tab 107 can be displayed in the user interface 101 (see, e.g., dashed arrow 123 indicating which expansion tab 107 has been selected). The incompatible parts 124 included in the list of incompatible parts 123 are parts that could be made to be compatible with the previously selected component through a modification or by adding intervening parts. For example, a first component having a first size may be incompatible with another component having a different size, but could be made compatible by adding an intervening part that steps up or steps down the size of the first component to make it compatible with the second component.

In an aspect of the present disclosure, an explanation for why the incompatible parts 124 are incompatible with a previously selected component can be displayed. For example, the explanation may be that an intermediate part is needed to make a first part compatible with a second part, or that a part stepping up or stepping down the size of a previously selected component is needed. Thus, a suggestion may be displayed for how to make the incompatible parts compatible with the previously selected component.

A recommendation may also be made for purchasing additional equipment, supplies, or other components that would be helpful in assembling the custom project after the parts are received. When a purchase link is provided, as described in more detail below, the purchase link may also include links to the additional helpful items. For example, if two 4 ft sections of wood are needed, and an 8 ft section that needs to be cut in half is being purchased, there might be a recommendation generated to purchase a saw for cutting the wood in half.

Referring particularly to FIGS. 10A-10D, an example is illustrated in which a caster (e.g., a wheel) is initially incompatible for addition to a tube, but is ultimately made compatible by adding a series of intermedia parts. The caster may be included as part of a pre-built assembly or a kit of parts that can be added with another component, such as the tube.

Referring particularly to FIG. 10A, selected tube 125 is not compatible with the casters displayed in the incompatible parts list 126. Thus, additional intermediate parts are needed and can be selected. First, coupler 127 can be added to tube 125.

Referring particularly to FIG. 10B, a caster fitting 128 is then added to the coupler 127, and the desired caster will now be populated to a list of compatible parts 129.

Referring particularly to FIG. 10C, the caster 130 can then be added to the caster fitting 128 to ultimately connect the caster 130 with the tube 125.

Referring particularly to FIG. 10D, a digital parts list 111 can be generated (e.g., by aggregating all of the parts selected during the virtual project build) by clicking a “parts list” tab 131. That is, when the virtual project build is completed, the application can provide a complete digital parts list 111 including all parts needed to build the project, and the digital parts list can be an executable list that can be used to actually purchase the parts on the digital parts list 111.

A signal to purchase at least some of the parts included in the digital parts list 111 may be received from the user. For example, the user may click a purchase tab 132 to purchase any or all of the available parts.

The application may display parts that are not currently available from one retailer and may make suggestions for alternative retailers carrying the parts that are not currently available from the one retailer. The application may also display a list of retailers from which the parts on the digital parts list 111 can be acquired, and the corresponding pricing each retailer is offering.

The digital parts list 111 can be printed or saved for later use by the user.

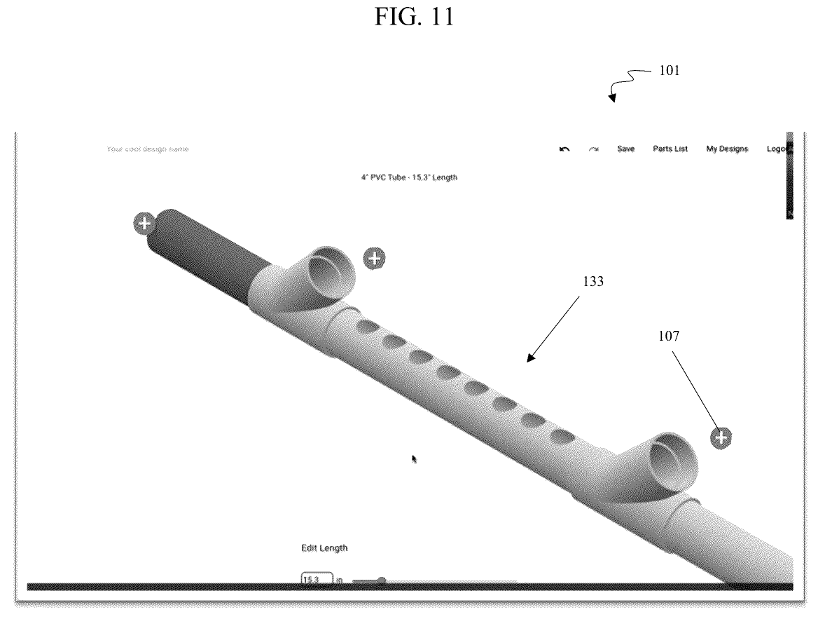

Referring to FIG. 11, a list of pre-built virtual projects can be displayed to the user, and the user selects one of the pre-built virtual projects instead of selecting a single starting component. The pre-built virtual project can then be customized by expanding a series of expansion tabs and selecting compatible parts, or incompatible parts that are made to be compatible. For example, pre-built virtual project 133 includes various expansion tabs 107 that can be executed to customize the pre-built virtual project 133.

As an example, the user can build an aquaponics system or use one that someone else previously built as a starting point. The user can modify a prebuilt aquaponics system to fit the user's needs.

The software application described herein can be run on a web browser (e.g., a web browser running on a desktop computer, laptop computer, tablet computer, or smartphone). The software application can also be downloaded as a standalone application configured to run a desktop computer, laptop computer, tablet computer, or smartphone.

Users can save projects and share saved projects with other users. A database of previously developed projects can be saved and made available for other users.

Previously completed or partially completed designs can be also made available for purchase between users.

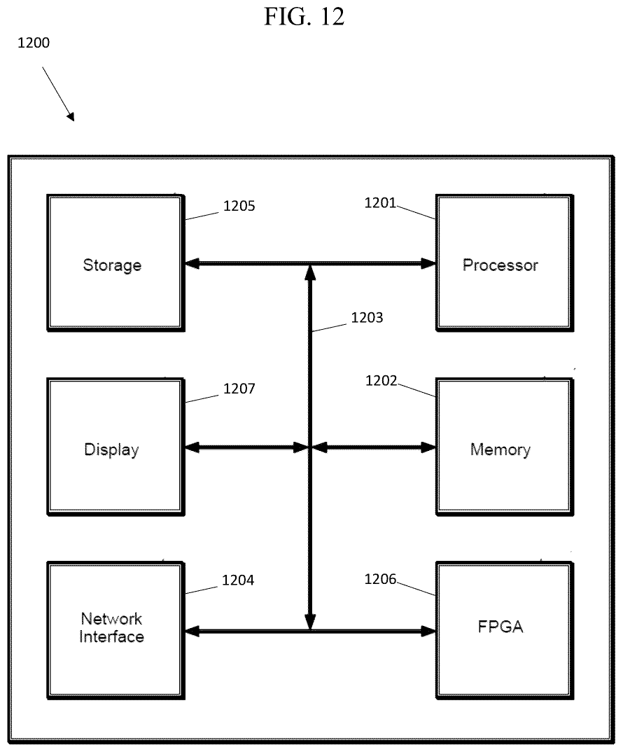

Referring to FIG. 12, a general-purpose computer 1200 is described. The general-purpose computer 1200 can be employed to perform the various functions described herein. The computer 1200 may include a processor 1201 connected to a computer-readable storage medium or a memory 1202 which may be a volatile type memory, e.g., RAM, or a non-volatile type memory, e.g., flash media, disk media, etc. The processor 1201 may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory 1202 can be random access memory, read-only memory, magnetic disk memory, solid state memory, optical disc memory, and/or another type of memory. The memory 1202 can communicate with the processor 1201 through communication buses 1203 of a circuit board and/or through communication cables such as serial ATA cables or other types of cables. The memory 1202 includes computer-readable instructions that are executable by the processor 1201 to operate the computer 1200 to execute the various functions described herein. The computer 1200 may include a network interface 1204 to communicate (e.g., through a wired or wireless connection) with other computers or a server. A storage device 1205 may be used for storing data. The computer 1200 may include one or more FPGAs 1206. The FPGAs 1206 may be used for executing various functions described herein. A display 1207 may be employed to display data processed by the computer 1200.

Exemplary configurations of the disclosure are described herein (e.g., with reference to the accompanying drawings). Like reference numerals may refer to like elements throughout the specification and drawings.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

The terms “part,” “product,” and “component” may be used interchangeably herein. Some of the parts described herein may be provided as a kit of multiple parts, that either can be assembled, or come completely or partially assembled. For example, the caster/wheel described herein may include a stop or brake that is pre-assembled with the caster or can be added to the caster with a limited amount of assembly. That is, each of the compatible parts described herein might include multiple parts that are or can be removably coupled with each other.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. A computer-implemented method of building a virtual project, comprising:
providing a user interface to a user, the user interface including a new project initiation button configured to be executed by the user to start building a virtual project;
displaying a list of initial components to the user, wherein each component included in the list of initial components can be connected with other components to start building the virtual project;
receiving, from the user, a selection of at least one starting component from the list of initial components;
displaying the at least one starting component in the user interface, wherein the at least one starting component displayed in the user interface includes at least one portion configured to connect with another component;
displaying an expansion tab in the user interface adjacent the at least one portion of the at least one starting component configured to connect with another component, wherein executing the expansion tab is configured to generate a list of compatible parts for the at least one portion of the at least one starting component;
displaying the list of compatible parts to the user, wherein each compatible part included in the list of compatible parts is configured to connect with the at least one portion of the at least one starting component;
receiving a signal from the user indicating a selected compatible part from the list of compatible parts;
displaying the selected compatible part connected with the at least one portion of the at least one starting component in the user interface, wherein the displayed selected compatible part connected with the at least one portion of the at least one starting component represents a partially built virtual project;
iteratively displaying one or more additional expansion tabs about the partially built virtual project and one or more corresponding additional lists of compatible parts for each of the one or more additional expansion tabs;
receiving a signal from the user that the virtual project is complete;
saving the completed virtual project in a computer memory; and
generating a digital parts list for building the completed virtual project after receiving the signal from the user that the virtual project is complete, wherein the digital parts list is executable to purchase each part included in the digital parts list.

2. The computer-implemented method of claim 1, further including receiving a signal to purchase at least some of the parts included in the digital parts list.

3. The computer-implemented method of claim 2, further including displaying a list of at least one retailer at which the at least some of the parts included in the digital parts list are available for purchase.

4. The computer-implemented method of claim 1, further including displaying a list of incompatible parts for the at least one portion of the at least one starting component, wherein the incompatible parts of the list of incompatible parts could be made to be compatible with the at least one portion of the at least one starting component.

5. The computer-implemented method of claim 4, further including displaying an explanation for why the incompatible parts of the list of incompatible parts are incompatible with the at least one portion of the at least one starting component.

6. The computer-implemented method of claim 5, further including displaying at least one suggestion for how to make the incompatible parts of the list of incompatible parts compatible with the at least one portion of the at least one starting component.

7. The computer-implemented method of claim 1, wherein the list of compatible parts for the at least one portion of the at least one starting component includes at least one of a size of the compatible parts, a material included in the compatible parts, or a class of the incompatible parts.

8. The computer-implemented method of claim 1, wherein the user interface is a 3-dimensional (3-D) interface, and wherein the 3-D user interface allows the user to click on the expansion tab to connect the selected compatible part with the at least one portion of the at least one starting component within the 3-D user interface.

9. The computer-implemented method of claim 8, wherein the user interface is configured to rotate at least one of the at least one starting component, the selected compatible part, or the partially built virtual project.

10. The computer-implemented method of claim 1, wherein the user interface is configured to modify a size or a length of the at least one starting component, or the selected compatible part.

11. A computer-implemented method of customizing a virtual project, comprising:
providing a user interface to a user, the user interface including a new project initiation button configured to be executed by the user to start customizing a virtual project;
displaying a list of pre-built virtual projects to the user, wherein at least one component included in the pre-built virtual project can be connected with other components to start customizing the virtual project;
receiving, from the user, a selection of at least one pre-built virtual project of the list of pre-built virtual projects;
displaying the selected at least one pre-built virtual project in the user interface, wherein the selected at least one pre-built virtual project includes at least one portion configured to connect with another component;
displaying an expansion tab in the user interface adjacent the at least one portion of the at least one pre-built virtual project configured to connect with another component, wherein executing the expansion tab is configured to generate a list of compatible parts for the at least one portion of the at least one pre-built virtual project;
displaying the list of compatible parts to the user, wherein each compatible part included in the list of compatible parts is configured to connect with the at least one portion of the at least one pre-built virtual project;
receiving a signal from the user indicating a selected compatible part from the list of compatible parts;
displaying the selected compatible part connected with the at least one portion of the at least one pre-built virtual project in the user interface, wherein the displayed selected compatible part connected with the at least one portion of the at least one pre-built virtual project represents a partially built customized virtual project;
iteratively displaying one or more additional expansion tabs about the partially built customized virtual project and one or more corresponding additional lists of compatible parts for each of the one or more additional expansion tabs;
receiving a signal from the user that the virtual project is complete; and
generating a digital parts list for building the completed virtual project, wherein the digital parts list is executable to purchase each part included in the digital parts list.

12. The computer-implemented method of claim 11, further including receiving a signal to purchase at least some of the parts included in the digital parts list.

13. The computer-implemented method of claim 12, further including displaying a list of at least one retailer at which the at least some of the parts included in the digital parts list are available for purchase.

14. The computer-implemented method of claim 11, further including displaying a list of incompatible parts for the at least one portion of the at least one pre-built virtual project, wherein the incompatible parts of the list of incompatible parts could be made to be compatible with the at least one portion of the at least one pre-built virtual project.

15. The computer-implemented method of claim 14, further including displaying an explanation for why the incompatible parts of the list of incompatible parts are incompatible with the at least one portion of the at least one pre-built virtual project.

16. The computer-implemented method of claim 15, further including displaying at least one suggestion for how the make the incompatible parts of the list of incompatible parts compatible with the at least one portion of the at least one pre-built virtual project.

17. The computer-implemented method of claim 11, wherein the list of compatible parts for the at least one portion of the at least one pre-built virtual project includes at least one of a size of the compatible parts, a material included in the compatible parts, or a class of the incompatible parts.

18. The computer-implemented method of claim 11, wherein the user interface is a 3-dimensional (3-D) interface, and wherein the 3-D user interface allows the user to click on the expansion tab to connect the selected compatible part with the pre-built virtual project within the 3-D user interface.

19. The computer-implemented method of claim 18, wherein the user interface is configured to rotate at least one of the at least one pre-built virtual project, the selected compatible part, or the partially built customized virtual project.

20. The computer-implemented method of claim 11, wherein the user interface is configured to modify a size or a length of the at least one of the at least one pre-built virtual project, or the selected compatible part.
